(19) United States
(12) Patent Application Publication
(10) Pub. No.: US 2005/0170166 A1
(43) Pub. Date: Aug. 4, 2005

(54) Laminated beams, boards, planks, and rails with enhanced stiffness and strength, made from nylon fiber composites

(76) Inventors: Forrest C. Bacon, Covington, GA (US); Wendell R. Holland, Covington, GA (US)

Correspondence Address: Patrick D. Kelly, 11939 Manchester #403, St. Louis, MO, 63131, US

(21) Appl. No.: 10/438,035

(22) Filed: May 13, 2003

Related U.S. Application Data
(63) Continuation-in-part of application No. 10/284,598, filed on Oct. 31, 2002.
(60) Provisional application No. 60/379,996, filed on May 13, 2002.
(60) Provisional application No. 60/404,465, filed on Aug. 19, 2002.

(51) Int. Cl. B32B 27/04

(52) U.S. Cl. 428/301.4

(57) ABSTRACT

Synthetic fiber composites (preferably containing nylon fibers obtained from recycled carpets) are made in laminated forms that can substitute for wooden boards, and even for structural beams (including studs, rafters, joists, etc.) in a framed house or other building. These laminates can be made from needle-punched fiber mats, which provide more extensive fiber intertwining than air-laid, bat-formed, or other fiber mats. In a preferred method of manufacture, sheets or wide strips are glued together, under pressure and using a non-foaming adhesive, to form oversized laminates having any desired thickness and desired length. The laminated sheets or strips are then sawed (such as by gang-ripping) into desired widths, to form edges that will not need additional trimming to remove excess adhesive. If suitable adhesives are used to form the adhesive layers, lamination can provide increased stiffness, compared to single-layer sheets having the same thickness. This increased stiffness can provide these laminated items with greater ability to withstand bending moments, torsional forces, and heavy longitudinal compression. These materials can also enable improved building designs and constructions that use less material, such as by increasing the spacings between adjacent studs, joists, and rafters.

### RELATED APPLICATIONS

This application is a continuation-in-part of U.S. utility application Ser. No. 10/284,598, filed on Oct. 31, 2002, which in turn claimed priority based on Patent Cooperation Treaty application PCT/US01/11895, published as WO 01/76869, which had an international filing date of 11 Apr. 2001.

This application also claims the benefit, under 35 USC 120(e), of provisional patent application No. 60/379,996, filed on May 13, 2002, and of provisional patent application No. 60/404,465, filed on Aug. 14, 2002.

### FIELD OF THE INVENTION

This invention is in the field of building materials, and relates to laminated beams, boards, and planks made from composite materials containing nylon or other synthetic fibers.

### BACKGROUND OF THE INVENTION

PCT application WO 01/76869 (Bacon et al) describes a process for making, from shredded carpet segments, synthetic composite materials with nylon fibers that can substitute for “sheetwood” products (such as plywood, particle board, “chipboard”, or oriented strand board (OSB)). The contents of that application are incorporated herein by reference, as though fully set forth herein.

Prior to the current invention described herein, the focus of the research and development described in PCT WO 01/76869 was on wood substitutes that are manufactured in sheets, comparable to plywood, rather than in narrow strips or other small items. There are two primary reasons for that prior focus on sheetwood substitutes.

The first reason is this: the method used to manufacture plywood substitutes, as described in PCT WO 01/76869, is ideally suited to making large and wide sheets of material. Briefly, that manufacturing process uses several cross-lapper machines, positioned next to a conveyor system, to lay a large, thick, and fluffy mass of combed nylon fibers across a slow-moving conveyor system that is roughly 13 feet wide. The cross-lapper machines lay continuous ribbons transversely across the conveyor system, until they generate a very large belt of material that covers essentially the entire width of the conveyor system. That large and fluffy mass of material, roughly 15 inches high and 13 feet wide, is then compressed, between rollers, to about 1/2 inch thickness. It is then run through a needle-punch machine, which uses large steel plates holding thousands of needles with barbs on their edges, to catch and pull thousands of individual fibers both upward and downward, in each square yard of material. The result is a densely interwoven needle-punched mat that will hold together strongly, even though it does not contain any chemical adhesive. That needle-punched mat is gathered, stored, and shipped in large rolls, usually 12 feet wide (to match standard carpet rolls) by 50 or 100 feet long.

These thick but flexible fiber mats were developed for use as padding and insulating layers, beneath carpets. However, years after those pads were first introduced, a method was developed (described in PCT application WO 01/76869) for using those same needle-punched fiber mats as feedstocks (or as intermediates), for making hardened materials that can substitute for plywood. By embedded two mats with a liquid adhesive that undergoes a “foaming” reaction (releasing millions of tiny gas bubbles, which drive the liquid through the entire thickness of both of the dense fiber mats), and by compressing the mats in a press while the adhesive hardens, a woodlike material in sheets, comparable to plywood, could be formed.

That entire process, using needle-punched mats made on conveyors that are conventionally 13 feet wide, is ideally suited to making sheets of material, rather than thin strips or other small pieces.

The second reason why the initial research and development focused on products that are made in sheets, rather than strips or small pieces, is that an efficient method already has been developed and extensively commercialized, for creating narrow strips containing recycled plastics. That manufacturing method uses a process called extrusion, to make strips of materials in sizes that resemble wooden planks or boards. A typical extrusion system for this type of recycled plastic material involves the following steps: (1) converting recycled plastics into a semi-liquid form, by melting it and mixing it with certain types of solvents, to give it a paste-like thickness and consistency; (2) forcing the paste-like material out of a high-pressure chamber, through an “extruder” orifice (outlet) that has a desired shape that will be imparted to the paste-like material being forced out through the orifice; (3) supporting the continuous “ribbon” of extruded semi-solid material on a conveyor system, to prevent it from sagging or deforming while it hardens; and (4) cutting the continuous ribbon of extruded material into convenient lengths, after it has hardened sufficiently.

In this manner, extrusion is used to create recycled plastic versions of wooden planks, typically having widths up to about 6 to 8 inches, and thicknesses up to about 2 inches (as used in the lumber industry, “thickness” refers to the smaller cross-sectional dimension, and “width” refers to the larger cross-sectional dimension; accordingly, a board or plank might be, for example, 6 inches wide and 2 inches thick). This type of “recycled plastic lumber” is sold by a number of companies, such as BJM Industries, Outwater Plastic Industries, Government Sales Associates, and PlasticBenches.com. Most purchases of these materials are by government agencies, since they are generally more willing than private consumers to pay premium prices, both to encourage recycling, and to avoid the risk of lawsuits by people who might sue if they get a splinter while sitting on an aging wooden bench.

Planks made of recycled plastics are used for a variety of outdoor uses, where waterproof synthetic materials will last longer (and less subject to forming splinters) than wooden planks that would be repeatedly soaked by rain or snow. As examples, most benches in parks and at bus stops are made from recycled plastic planks, and companies also make deck materials from recycled plastics. Information on such materials can be obtained from various websites, including www.governmentsales.com.

Accordingly, for both of those two reasons—recycled plastic materials were already available in extruded forms that substitute for planks and boards, and the Applicants began working on this project by doing tests on large needle-punched mats—the Applicants focused their initial attention solely on sheets, rather than strips, planks, or boards.

However, it should be recognized that wood substitutes made from recycled plastics have their own limitations and shortcomings. One of the main limitations is that nylon is rarely used to make recycled plastic planks, since the melting temperature of nylon (roughly 570° F.) is much higher than the melting temperatures of the plastics that are used to make recycled plastic planks (those plastics mainly include polyethylene, polyethylene terephthalate (PET), polyvinylchloride (PVC), polypropylene, and polystyrene, and their melting temperatures are generally in the range of about 225 to 325° F., which is hundreds of degrees lower than the melting temperature of nylon). Therefore, recycled plastic lumber offers no significant help, in creating ways to reduce the enormous solid waste problems formed by discarded carpets.

In addition, extruded plastic lumber is not as strong as wood, and is more fragile and difficult to work with than wood. To illustrate these problems, here are some excerpts from the instructions provided by www.governmentsales.com: “Unless structurally reinforced, Recycled Plastic Lumber is NOT recommended for ANY structural applications. It is 5 or 6 times more flexible than wood . . . When nailing, take extra care at the board ends—a nail can split the board . . . With either a hammer or pneumatic nailer, take special care not to damage the decking, or drive the nails too deep. Nails should be set just a little below the surface by driving them until they are almost flush with the decking and then finishing with a nail set . . . Installing screws is slower . . . When plastic lumber is bundled and subject to temperature change, some of the boards are going to be crooked. They may have some cupping or a curve or bow from one end to the other . . . If the board cannot be moved into position, you can do one of two things. The quickest solution is simply to crosscut the board in half, which divides one long board into two more manageable pieces, and adding a butt joint. If you do not want to add this additional joint, then try to wedge the board into position . . . ”

As suggested by these quotes, it should be clear that even though “recycled plastic lumber” can be useful, and offers a good outlet for some types of recycled materials, it is also limited, and suffers from various shortcomings.

One of the most important limitations and shortcomings in “recycled plastic lumber” is encapsulated in the following two sentences: “Unless structurally reinforced, recycled plastic lumber is NOT recommended for ANY structural applications. It is 5 or 6 times more flexible than wood.”

An understanding of this sentence requires attention to the word “structural”. Clearly, any use of “recycled plastic lumber” can be regarded as a “structural” use. As a simple example, if someone is sitting on the seat of a park bench or picnic table, that person clearly is sitting on a structure.

Nevertheless, the meaning of the quoted sentence above becomes clear when one recognizes that in the building industry, there are well-understood distinctions between relatively thin categories of lumber, commonly referred to as “boards”, and heavier, thicker, and stronger categories of lumber, commonly referred to as “beams”. Those distinctions can be understood by briefly considering various types of structural elements that are found in a typical wood-frame house. As used herein, the terms used below are used in the conventional manner that is familiar to and understood by people who build or repair homes. These terms are also illustrated in numerous encyclopedias, websites, home repair guides, and similar reference works. If any questions arise over borderline cases, they can be resolved by reference to publication D9-87, “Standard Terminology Relating to Wood” (1999), issued by the American Society for Testing and Materials (ASTM; www.astm.org).

The following discussion refers to lumber sizes in inches, since metric sizes have not been adopted by the American lumber industry, and since essentially all lumber and lumber substitutes sold in America are sold with sizes specified in inches. If anyone wishes to convert the sizes below to metric sizes, he or she is welcome to do so, with the following assistance. A conventional “2 by 4” used as a stud or rafter has a “nominal” metric size of 5.08 by 10.16 cm, and an actual size of about 3.8 cm by 8.9 cm (or about 4 by 9 cm). A 2 by 8 used as a joist will have nominal dimensions of 5.08 by 20.32 cm, and actual dimensions of about 4 by 19 cm. Any other metric conversions can be performed by using the conversion factor of 1 inch equals 2.54 cm, and 1 foot equals 30.48 cm.

Unless and until architects and others begin specifying alternate sizes, any laminated fiber beams as disclosed herein preferably should match the widths and thicknesses of the wooden components they are replacing. This will enable these laminated beams to be substituted, smoothly and efficiently, in place of the wooden studs, rafters, and other components they are replacing, with no conversion problems, and without causing minor alterations in wall or floor thicknesses or room dimensions. This will help ensure that an actual building will match up properly with any architectural or construction drawings. It should also be noted that in countries where beams or boards are sold with metric or other dimensions, any laminated fiber beams as disclosed herein should be sized (at least initially) to match the wooden beams or boards that are commonly sold in those countries.

Returning now to the various types of beams that are commonly used in the construction of wood-framed houses and other buildings, a stud refers to a beam that is positioned vertically. Except in unfinished attics and basements, most studs are hidden within a wall or similar structure, and usually span the distance from a floor to a ceiling. In some locations, studs can help provide vertical support for a door or window casing, a rafter, an appliance or plumbing device, or some other structure. In the United States, most studs are made from 2 by 4 inch softwoods (nominal size; actual dimensions are usually 1.5 by 3.5).

Not all vertical supports are called studs. An especially large, important, or prominent vertical support is often called a post, rather than a stud, regardless of whether it is inside or outside of a wall. In addition, nearly any type of columnar vertical support that is plainly visible and that is not part of a wall is usually called a post, and may also be called a column.

A joist generally refers to a horizontal support for a floor and/or ceiling. Because of the heavier loads that are placed on joists, they almost always have at least 6 inches (nominal) width (actual width is usually about 5.5 inches), and usually are 8 or 10 inches wide. Joists are usually spaced at regular intervals, with their centers typically from 15 to 18 inches apart.

An especially large or important horizontal or sloping support is often called a beam, rather than a joist. Typically, the ends of any joists are supported by beams, if not supported directly by a concrete wall. As examples, in many homes constructed after about 1950, one or more thick steel posts, usually round or with an I-beam shape, is/are placed near the center of an open space, and used to support a long wooden or steel beam, which in turn will support joists on both sides of the beam, which travel to external or other walls. This design allows larger and wider open spaces, interrupted only by one or a small number of posts, in a basement or other large room. Similarly, a typical gabled roof usually has a “crown beam” at the top, which helps create and support the ridge at the top of the roof. Similarly, many homes have one, two, or more beams which are larger than joists, and which are often visible, to help support a vaulted or cathedral ceiling.

A rafter generally refers to a sloping support that: (i) will help support a roof or other sloping structure, and (ii) is merely one of a series of such supports, rather than being a prominent or enlarged beam. Most rafters are made of 2 by 4's, and they typically support sheets of plywood, OSB, or other sheet material, which in turn will support a layer of shingles or other roofing material.

A truss usually refers to a non-rectangular sub-assembly that is constructed on the ground, in a factory setting, or in some other convenient location, and then moved into a position where it will become part of a building. For example, most sloping roofs on homes are made by erecting a series of trusses, all of which have essentially identical triangular sizes and shapes, into positions where they line up with each other, standing vertically and spaced even distances apart from each other. They usually are connected to each other, and to the supporting walls, by a crown beam at the top, and by various angled reinforcing members that connect certain trusses to various joists that are used to make the uppermost ceiling and the floor of the attic space. All of the wooden members of a truss are defined as “truss members”, and all truss members are classified as beams, as that term is used herein.

A casing refers to the pieces of wood that are used to create and surround an opening (which usually will be rectangular) in a wall (either internal, or external) that will be filled by a door, window, or comparable device. Although most casings are made of 2 by 4's (which are inexpensive, easy to handle and work with, and do not require highly accurate nailing), some casings contain smaller pieces that would not be regarded as beams, such as 2 by 2's.

These are the major “beam” components used in home construction, but various other beam-class components are also known to carpenters (such as stringers, which help support stairs). In a finished building, most of these structural components will be covered and hidden by dry wall, flooring, ceiling panels, or other materials, except in “unfinished” areas, such as an unfinished basement or attic.

In a conventional framed house, the loads that are placed on studs and rafters are generally lower than the loads placed on joists, beams, and posts. Therefore, studs and rafters can be placed in one subcategory, in terms of their size and strength requirements, while joists, beams, and posts should be placed in a higher subcategory. This is reflected in their conventional sizes; studs and rafters almost always are made of standard, untreated pine 2 by 4's, while any joists that do not rest on concrete or some other hard surface usually are made of 2 by 8's or 2 by 10's, and are often made of wood that has been treated by pressure, chemicals, etc., to render it harder and/or more bug resistant.

Accordingly, studs and rafters can be used to provide a lower-level benchmark (or threshold, plateau, etc.), to determine whether laminated beams made of synthetic fiber composites are fully and adequately qualified for use in housing or other building frames. If laminated beams made of synthetic fiber composites can be manufactured with sufficient strength, stiffness, and durability to provide safe, reliable, and durable synthetic replacements for the types of untreated pine 2 by 4 studs and rafters that are widely used in conventional wood-framed homes, then these laminated synthetic fiber composites can provide highly useful and valuable products, regardless of whether these products can also qualify as replacements for joists, posts or other heavier and larger frame components that are normally made of larger pieces of wood. If these laminated synthetic fiber composites can qualify to replace studs and rafters in conventional framed homes, then they can greatly reduce and alleviate a major solid waste problem, and they can also greatly reduce the need to cut down more and more trees, even if they never qualify for use as joists or other larger load-bearing beams.

On the subject of laminated synthetic fiber beams “qualifying” as replacements for rafters or studs, the information in a section below, entitled “Government-Required Approvals; Material Safety Data Sheets,” should be considered. Briefly, it will not be legally possible for any manufacturer to “sneak in” these types of laminated synthetic fiber beams, in place of wooden beams, without telling anyone. Instead, these laminated synthetic fiber beams will need to be tested and qualified for such use, using test procedures approved by organizations such as the American Society for Testing and Materials (www.astm.org) and the American National Standards Institute (www.ansi.org), before they can be used as structural beams in any buildings that will be occupied by humans (since occupied buildings require permits, financing, insurance, etc.). In addition, any laminated synthetic fiber beams used in occupied building will need to be accompanied by “Material Safety Data Sheets”. These safeguards will ensure that laminated synthetic fiber beams will not be used in actual building construction, unless and until they've been tested and proven to have sufficient strength, stiffness, and durability to qualify for such use.

In outdoor settings on land (such as with decks, gazebos, fences, etc.), certain terms are used in a manner that can vary from indoor usages. As examples, the term post is often used to refer to any vertical support member, regardless of where it is located, or how large or strong it is, and the term plank is usually limited to horizontal boards that provide a walking surface.

In marine use, still other terms are used for load-bearing structural components. In particular, piling usually refers to a vertical member that is driven into a mud or sand surface, below the water.

In addition, in outdoor or marine settings, the term rail is commonly used to refer to any horizontal member that is higher than the main floor of a deck, pier, or other structure, or that is above ground, in a fence. As a general rule, any rail on a deck, dock, or fence should be able to withstand fairly high loads, unless it is totally obvious that it is merely for decorative, pet enclosure, or similar purposes, rather than structural purposes. In decks and piers, rails generally must be able to withstand adults leaning or sitting on them, and children climbing on them, without posing any jeopardy of collapse. Similarly, any rail in any fence must be able to withstand the highest shear forces and bending moments that will be caused by gusts of wind during severe storms.

Using the standard dictionary definition of beam (“a large, oblong piece of timber, metal, or stone, used especially in construction”, from the American Heritage Dictionary, second college edition, 1985), load-bearing structural components are referred to herein by the general term “beams”, to distinguish them from boards (which are thinner), and from sheets or panels of material. As summarized above, the term “beam” as used herein includes any piece of wood, or synthetic wood substitute, that is designed and sized so that it can be used as any one or more of a stud, post, joist, beam, rafter, truss member, rail, or piling.

Load-bearing beams must be designed to withstand any and all types of loads that will or may be imposed on them (including shear forces, bending moments, and torsion, described below). Therefore, they must be thicker and stronger than boards, sheets, or panels.

Because sheets of adhesive-impregnated nylon fiber composites, as described above, have greater strength and resilience than comparable types of plywood or OSB (which is usually made from pine or other forms of softwood), the Applicants herein decided to carry out some preliminary tests to evaluate laminated strips, made by gluing together stacks of strips that had been sawed from sheets made from needle-punched mats.

While testing some early prototypes that were made after the Applicants had settled on certain types of adhesives, the Applicants realized that their laminated beams had an unusually high level of stiffness, and could not be bent in the ways that otherwise would have been considered normal and predictable, based on similar bending tests using thicker but non-laminated sheets.

Therefore, they realized that higher levels of stiffness, in their laminated strips, could translate to higher levels of strength, for laminated synthetic structural beams.

This arises from the fact that structural beams in a building must be able to withstand various types of forces that go far beyond mere compression and tension. First, it must be noted that either compression or tension can be applied in multiple directions. Using a vertical stud as an example, longitudinal compression or tension can be applied vertically, and there are two different types of transversely compression or tension (one transverse to the 1.5 inch thickness of the stud, and one transverse to the 3.5 inch width of the stud). In this context, “transverse” refers to any force or direction that is roughly perpendicular to (or at least substantially different from) a “longitudinal” force or direction, which is oriented along the length or main axis of an elongated object (to simplify various types of analyses when it comes to forces, any angled force can be regarded as a vector, comparable to an arrow that has both a direction, and a length which represents magnitude; the angled vector can be regarded as the sum of a longitudinal vector, and a transverse vector; accordingly, any angled force that has a transverse component can be regarded as imposing that amount of transverse force on the beam).

Forces such as compression and tension are just the beginning. Different compressive and lateral forces can combine to form potentially destructive “shear forces” and “bending moments”.

In layman's terms, shear forces generally includes two transverse forces that are imposed in different directions but relatively close to each other, so that a structural member which must resist those two forces is in danger of being sheared off, in a manner comparable to being cut by a pair of scissors, or shears.

The term bending moment is similar, but it refers to two or more transverse forces that are imposed on a beam, at locations that are sufficiently far apart, along the length of the beam, to cause the beam to bend, rather than being cleanly sheared off. As an example of a bending moment, if the two ends of a beam that is eight feet long are supported on blocks or sawhorses, and a heavy weight is placed in the middle, that beam may break, somewhere in the middle, because of the large “bending moment” imposed on it. Instead of being sheared cleanly, it will fail in tension, somewhere along the bottom surface, usually creating splinters and strands that are several inches or even several feet long. Accordingly, “bending moment” refers to a combination of forces that will cause a beam to bend, usually into a curved or “bowed” shape.

Shear forces and bending moments can overlap, and in some cases, a single type of force might be regarded as either or both types of forces. As an example, if a high wind blows against a section of fence, and causes one of the posts which supported that section of fence to break, the force that was imposed on the fence, by the wind, could be regarded as either a shear force, or a bending moment.

It should also be noted that if a heavy longitudinal compressive load is imposed on a long piece of wood that is naturally bowed or bent (even if by only a small amount), or if a piece of wood begins to deflect and deform into a bowed shape when a heavy longitudinal load is imposed on it, that longitudinal load will be effectively converted into a bending moment. As the amount of deflection increases, even by small fractions of an inch, the magnitude of the bending moment grows substantially greater. Therefore, if a structural beam can be reinforced in a way that increases its stiffness, and helps it resist and minimize any bowing or other transverse deflections, it may be able to withstand substantially higher longitudinal compressive loads.

Shear forces and bending moments are among the most dangerous threats, to any long piece of wood. Either of these types of force can break a long piece of wood, even though that same piece of wood could easily withstand compressive loads that are dozens of times higher, if the wood were sitting squarely on a flat and smooth supporting surface, such as a concrete floor in a garage.

Torsion must also be considered. It includes twisting forces that are applied along the main axis of an elongated component. Although large torsion forces are rarely imposed in isolation on any one particular structural beam in a building, torsion forces can become important during storms, when gusts of wind impose rapidly changes forces and stresses on a sloped roof of a house. Since homes are at high risk of damage during severe storms with high winds, those are the types of events and conditions that building frames must be designed to withstand.

When the Applicants realized that all of these types of useful and desirable strengths, in structural beams, can be promoted and enhanced by increased stiffness in a structural beam, they recognized the potential value of their discovery that laminated strips of fiber composites are stiffer (when suitable types of adhesives are used) than similar composites having comparable thicknesses, but no laminating adhesive layers.

In passing, it also should be noted that, in contrast to the types of hardness and strength that are desirable in structural beams, most types of sheet and paneling products are deliberately designed to yield and fail, if subjected to moderate or severe impacts, thereby reducing the risk of damage to other, more valuable things. As one example, children are less likely to be seriously injured, if an elbow, knee, or head hits a piece of dry wall during a wrestling match or game of chase, if the dry wall will yield, break, and form a hole. Since a hole in a drywall can be repaired at much lower cost than a trip to a hospital, most parents, building designers, and companies that sell building materials would much rather have drywall yield and break, than to have it so strong that it will break bones if an impact occurs. As another example, if a falling tree lands on a rooftop, it will do less damage to the structure as a whole, if the shingles and the sheets of plywood or OSB where the tree lands (as well as a few rafters, which are deliberately spaced more than a foot apart) will yield and break, thereby absorbing a substantial part of the energy of the blow from the falling tree. For these reasons, sheet products such as plywood, OSB, and drywall are intentionally designed to not have the same high levels of strength and hardness as structural beams.

In addition to providing laminated beams, this invention also discloses boards and planks that are laminated, with at least two layers of fiber composite materials, and at least one layer of adhesive positioned between fiber composite layers.

In lumber and construction terminology, boards and planks are general terms that refer to pieces of lumber that are not as thick as load-bearing structural beams. There is no universally-agreed-upon precise size boundary between “beam” and “board”, and those terms become even more uncertain, when applied to non-wood products such as “recycled plastic lumber”. However, for practical purposes, when referring to actual wood, standard 2 by 4's (i.e., 2 inch by 4 inch nominal size, actual size 1.5 inch by 3.5 inch) provide a lower size limit for “beams”. Any elongated piece of lumber that is thinner and/or narrower than a 2 by 4 (i.e., that is smaller in either of those cross-sectional dimensions) is almost always called a board, rather than a beam (or stud, rafter, joist, etc.).

Similarly, the term plank is not always used consistently, either in dictionaries, or in the construction industry. Some people use it interchangeably with “board”, while others use it to refer to a piece of wood that is thicker than a board, but thinner than a beam. In a third usage, “plank” refers to boards that are laid horizontally, to make a walking surface such as a floor or deck.

Since patent claims relating to manufactured items should not depend on an intended use for the item, the term “plank” is not favored herein, and is used as a subset of the word “board”. Therefore, any reference herein to laminated boards also includes laminated planks. In practical terms, either of these terms includes any elongated piece of laminated fiber composite that has a thickness of less than 1.5 inches and/or a width of less than 3.5 inches. By contrast, any piece of laminated fiber composite that has a thickness of at least 1.5 inches, and a width of at least 3.5 inches, is referred to herein as a laminated beam.

Laminated boards (and planks) are covered by this invention, since lamination can provide increased stiffness, strength, and durability, and can enhance the appearance, value, and performance traits of structures made from these types of building materials.

It should be noted that appearance should be taken into account, in evaluating materials that can be provided with increased thickness by lamination. Although the thicknesses of boards and planks in indoor construction often goes unnoticed, the side edges of boards and planks are usually visible in outdoor or marine structures such as decks, gazebos, fences, piers, and docks. Even if a relatively thin layer of a super-strong high-tech synthetic composite material could provide all necessary strength and durability with a generous margin of safety, the visual appearance of an outdoor structure will either contribute to, or detract from, the sense of confidence, security, and other intangibles that are felt by owners, users, visitors, and prospective purchasers or lessees. As with any other type of real estate, appearance has important impacts on the appraisal price, rental price, sale price, or other commercial value of a deck, pier, or other outdoor structure. Accordingly, the simple question of how thick the boards or planks are, in an outdoor structure, will carry silent but important messages about their strength, safety, durability, and remaining life. Those messages can heavily affect the value of a piece of property.

Furthermore, any owner of an outdoor or marine structure will be properly concerned with its durability, not just over a span of years, but over a span of decades. Although no hard data are yet available on how long these newly-invented synthetic composites will last in various outdoor and marine settings and climates, there is every reason to presume that, under any given set of conditions, thicker laminated boards will last longer, and remain stronger, than thinner laminated boards.

It also should be recognized that lamination may be able to reduce the costs of at least some types of fiber composite boards and planks. Using an inexpensive adhesive to glue together two or more moderately thin layers of fiber composites may be less expensive than manufacturing a single sheet of thicker material, if the single sheet of thicker material would require expensive adhesives that must be carefully selected, so that they will permeate thoroughly and uniformly through thick layers of densely interwoven fiber mats.

For all of these reasons, laminated boards, planks, and rails are covered herein.

One object of this invention is to disclose laminated beams, boards, and planks, made from strips of nylon fiber composites that have been glued together by adhesives that provide increased stiffness and strength.

Another object of this invention is to disclose laminated beams, made with recycled or other nylon fibers, that have higher strength and stiffness than any types of non-metal lumber substitutes that are known in the prior art.

Another object of this invention is to disclose laminated beams, boards, and planks made with nylon fiber composites, that can be handled by processes that include sawing, drilling, nailing, screwing, etc., that are waterproof and bug-proof, and that can be provided with essentially any desired thickness, width, and length.

Another object of this invention is to disclose methods of making studs, joists, rafters, beams, and other structural components of homes and other buildings, that can substitute for wood and that can be sawed, nailed, and otherwise handled like wood, but that are waterproof and bug-proof and have high levels of strength and durability, and that can be made from nylon fiber composites, using sources such as discarded carpet segments.

Another object of this invention is to disclose a method for manufacturing laminated beams, boards, and planks from nylon fiber composites, having high levels of stiffness, strength, and durability.

Another object of this invention is to disclose buildings and building designs, in which the spacing between adjacent studs, joists, or rafters made of laminated fiber composites has been increased, compared to the spacing of adjacent wooden components, in a manner that reflects the increased strength and stiffness of these laminated composites, compared to the strength of wooden beams.

These and other objects of the invention will become more apparent through the following summary, drawings, and detailed description.

### SUMMARY OF THE INVENTION

Synthetic fiber composites (preferably containing nylon fibers, which can be virgin, or obtained from recycled carpets) are disclosed, in laminated forms that can substitute for wooden beams, boards, and planks. These laminated items are made from sheets or strips of fiber composites, which in the higher grades of laminates preferably should be made from needle-punched fiber mats, which provide greater degrees of fiber intertwining than air-laid, bat-formed, or other fiber mats. In a preferred method of manufacture, sheets or strips are glued together, under pressure and using a non-foaming adhesive that will bond tightly to the sheets or strips, to form oversized laminates having any desired thickness, and any desired length. The oversized laminates are then sawed (such as by gang-ripping) into desired widths, to form edges that will not need additional trimming to remove excess adhesive.

The alternating layers of fiber composites and adhesives can provide added stiffness to these laminates. This increased stiffness can provide these laminated items with greater strength and durability, due to factors that include increased ability to withstand high bending moments and torsional forces, and increased ability to prevent high longitudinal compressions from being converted into destructive bending moments, by bowing or other deflection of a beam or board.

Accordingly, these laminated beams, boards, and planks are well-suited for use as studs, joists, rafters, beams, and other structural components in homes and other buildings, and as structural and planking components of decks, piers, docks, and other outdoor and marine structures.

Since these materials have strengths substantially higher than most forms of wood, they can also enable improved building designs and constructions that use fewer materials, such as by increasing the spacings between adjacent studs, joists, and rafters. Accordingly, these buildings can be less expensive to build, and more energy efficient, and can provide other benefits as well.

### BRIEF DESCRIPTION OF THE DRAWINGS

FIG. 1 depicts a laminated beam in the size of a standard “2 by 4”, having dimensions of 3.5 inches in width by 1.5 inches in thickness, for use as a stud, rafter, or door or window casing in a house or other building, formed by gluing together 3 layers of a nylon fiber composite that was initially manufactured in sheet form.

FIG. 2 depicts a laminated stud, made of composite strips and adhesive layers that span the thickness rather than the width of the stud.

FIG. 3 depicts a laminated joist.

FIG. 4 depicts a laminated board or plank, made of two wide strips of thin composite.

### DETAILED DESCRIPTION

As briefly summarized above, this invention relates to wood-like building materials, made of laminated layers of composites that contain synthetic fibers, such as nylon fibers. These building materials are manufactured with lengths, widths, and thicknesses that render them suitable for use as:
1. Beams, in construction of a conventional framed house. As used herein, the term “beam” includes studs, joists, rafters, posts, beams, and truss members, as those terms are used by carpenters and home-builders.
2. Rails, as that term is used in relation to decks, docks, fences, and other outdoor or marine structures.
3. Boards and/or planks. As used herein, these terms are interchangeable, and refer to pieces of wood or wood substitutes that do not have sufficient thickness to be safely and reliably used as load-bearing beams in a conventional framed house.

When referring to wood, an arbitrary dividing line between “beams” versus “boards” can be provided by standard 2 by 4's, which are 1.5 inches thick and 3.5 inches wide, and which provide the smallest beams. If a wooden board has a thickness less than 1.5 inches and/or a width less than 3.5 inches, then it is not classified as a “beam”, as that term is used herein, and instead is referred to herein as a board or plank.

However, it should be recognized and understood that synthetic substitutes for wood do not comply by that arbitrary size boundary. As noted in the Background section, “recycled plastic lumber” is not recommended for any structural applications, to replace wooden beams, since “it is 5 or 6 times more flexible than wood”. Therefore, any large piece of “recycled plastic lumber” would be referred to as a board or plank, rather than a beam, regardless of how wide and thick it is.

In the opposite direction, since laminated nylon fiber composites as disclosed herein appear to have substantially higher strength than pine (which is used to make conventional 2 by 4's), strips of these materials can be made that may have sizes slightly less than 1.5 inches by 3.5 inches, but that are specifically designed to have sufficient strength and stiffness to replace studs, rafters, and other beams made of 2 by 4 pine wood. If the need arises, the question of whether such an item or material should be classified as a “beam” or a “board” can be resolved by determining whether that particular item has been declared to be structurally adequate as a substitute for wooden 2 by 4's, based on testing carried out using standard testing methodology specified by ASTM or ANSI.

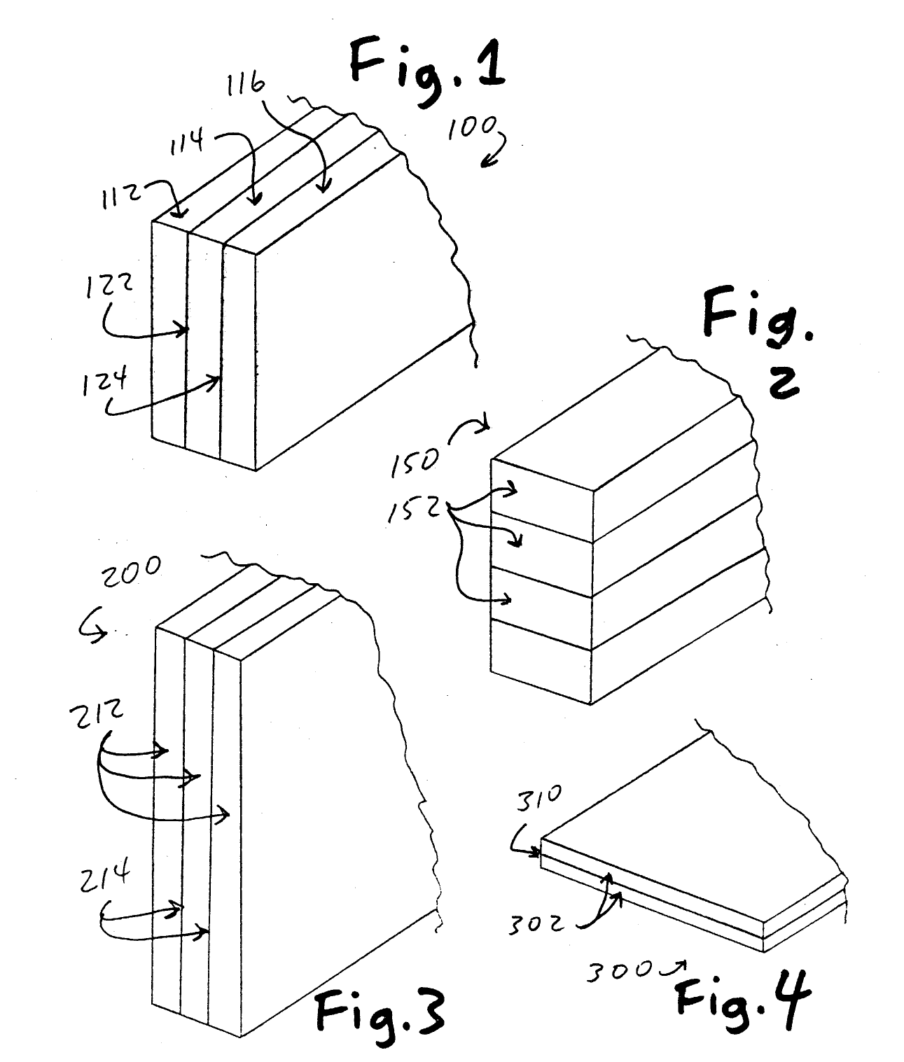

FIG. 1 illustrates a segment 100 of a laminated beam that can be used as a substitute for a conventional pine stud or rafter having a “nominal” cross-sectional area that is 2 inches thick, by 4 inches wide (actual size 1.5 inches by 3.5 inches; as mentioned in the Background section, “thickness” refers to the smaller cross-sectional dimension, while “width” refers to the larger cross-sectional dimension, so that a board might be, for example, 10 inches wide, and 1/2 inch thick). Laminated segment 100 comprises three strips 112, 114, and 116 of nylon fiber composite material, each cut from a larger sheet with 1/2 inch thickness. These three layers 112-116 of nylon fiber composite are held together by two layers 122 and 124 of a strong adhesive.

FIG. 2 illustrates a similar segment 150 having the same size as segment 100; however, in segment 150, the laminated layers 152 are oriented transverse to the thickness, rather than the width, of the resulting beam.

FIG. 3 illustrates a larger segment 200 of a laminated beam that can be used as a joist, beneath a floor. This segment, which has dimensions of 1.5 inches in thickness and 9.25 inches in width (to match a nominal 2 by 10 joist), is made from 3 layers 212 of fiber composite, and 2 layers 214 of adhesive. Increased numbers of layers can be used, if desired, to give a resulting laminated beam a higher level of stiffness and strength, if a very strong epoxy adhesive (such as a non-foaming isocyanate-polyurethane epoxy) is used.

FIG. 4 illustrates a relatively wide board or plank 300, made of two fiber composite strips 302, each having a thickness of about ¼ to 1/2 inch, held together by adhesive layer 310.

Potential Fiber Types and Sources

Nylon fibers that are suited for use in making laminated composites as disclosed herein can be obtained from sources such as discarded carpet segments (which are generally categorized as either “post-industrial” carpet waste, which was never installed or walked on, or as “post-consumer” waste, which was installed on a floor and later removed). Alternately, because high levels of strength, durability, and value can be provided by the products disclosed herein, virgin fibers can be purchased and used, if desired, either alone or mixed with recycled fibers.

Any mixture or blend of nylon fibers made from either nylon-6 or nylon-6,6 can be used as disclosed herein, mixed together in any ratio. Despite their use of the same digit, those two different classes of nylon have substantially different chemical structures. These chemical differences created major problems, in prior art recycling processes that were designed to either: (i) melt and extrude recycled nylon, in a form such as a plank for a park bench, or (ii) chemically break down nylon, to convert it back into its constituent monomers. By contrast, in needle-punched mats used to create sheetwood materials (as disclosed in PCT application WO 01/76869) or to create laminated beams, boards, or planks as disclosed herein, the chemical differences between nylon-6 and nylon-6,6 do not pose any significant problems. Any blend with any ratio of nylon-6 and nylon-6,6 fibers can be used, without requiring sorting or separating steps.

For laminates that will be used as load-bearing structural beams, nylon fibers are generally preferred, because of their high strengths and various other traits. However, other fiber types can be included in these laminates if desired (especially in laminates that will be used to provide boards or planks that will not need to bear large loads, and/or for laminates intended for indoor use, where they likely will not get wet), provided that the resulting fiber mixtures can achieve the goals of the intended products at acceptable levels. Such other fiber types that can be evaluated to determine whether they are suitable for a laminate intended for any particular type of use can include natural fibers such as cotton and wool, and synthetic fibers, such as polyesters.

In addition, laminates as disclosed herein can also contain synthetic fibers that have exceptionally high strengths. An example of such super-strong fibers includes “aramid” fibers, sold by DuPont under the trademark KEVLAR. These fibers, which reportedly have five times the tensile strength of steel, on a per-weight basis, are used in bulletproof vests and other items in which extremely high strength is worth the additional cost. Accordingly, laminates that are made as disclosed herein, using aramid or other super-strong fibers that have been (1) needle-punched to generate densely interwoven mats, (2) bonded by strong adhesives into hardened sheets, and (3) converted into laminates, deserve special evaluation, not just as building materials but for a wide range of potential high-tech uses (including military, aerospace, etc.), because they may be able to provide extremely strong structural items.

Non-Identical Layers

To be covered by this invention, any laminated item as disclosed herein must contain at least two layers of fiber composite materials, and at least one layer of adhesive between them.

However, the laminates disclosed herein do not need to be made from layers that are identical, so long as: (i) any given layer is compatible with the adhesive that must stick to it, and (ii) the complete item, including all layers, is able to provide an acceptable and useful substitute for a wooden beam, board, plank, or rail.

As one example of a laminated articles that could have different types of fiber composite layers, and that could substitute for conventional studs or rafters made of 2 inch by 4 inch pine, it may be sufficient to provide two outer layers that contain nylon fibers, to provide sufficient strength, while using an internal (“sandwiched”) layer that is less expensive to manufacture, and that does not have the same strength or hardness as the outer layers. A less expensive internal layer could be made in any of numerous ways. As non-limiting examples, it might have a lower nylon fiber content, or no nylon fibers at all; it might use a very inexpensive adhesive within the internal layer; it might be cured and hardened at a low pressure, to provide a low density and reduced weight; and, it might be made of a material comparable to dry wall, with few or no fibers.

Manufacturing Processes

To provide the levels of strength that are preferred for use herein (especially in laminates that will be used as load-bearing structural beams, rather than merely as lesser-grade boards or planks that will not need to bear heavy loads), the fiber composite layers should be initially manufactured, preferably in sheet form, and preferably using methods (such as needle-punching) that will generate at least some significant degree of intertwining, within a fibrous matrix. Stated in another manner, methods of manufacture that generate substantial intertwining of the fibers in a fibrous matrix (such as needle-punching, which is specifically designed to yank large numbers of fibers up and down in a large sheet that can be mass-manufactured at relatively low cost) are likely to provide stronger and more durable wood substitutes than can be generated by other methods that, for example, merely lay coiled strands or wadded-up bundles of fibers in a mold cavity or similar device, without making any particular effort to intertwine the fibers and convert them into a true matrix.

However, it also should be recognized that there are means other than needle-punching which can provide significant degrees of fiber intertwining. As examples, two processes known as bat-forming and air-laying can be used to generate some degree of fiber intertwining, especially if used in combination with certain types of combing, rolling, blending, or other mechanical fiber-handling operations. Accordingly, these types of operations can be tested, using routine experimentation, to evaluate the strengths of the hardened plywood-like sheets of materials they will generate, and then to evaluate the strength and stiffness of laminated composites that can be manufactured by such methods. If such methods are used, instead of needle-punching, to manufacture various lesser grades of laminated composite materials that will be adequate as substitutes for at least some types of boards, planks, rails, or possibly even beams, then such materials are deemed to be included within various claims set forth below that do not explicitly require needle-punching as a limitation.

As described above and in PCT application WO 01/76869, various initial manufacturing steps (such as needle-punching to form a fibrous mat, followed by embedding two mats with a foaming adhesive, and allowing the adhesive to cure while the two mats and the adhesives remain under pressure in a mold or press) can be used to manufacture hardened wood-like materials in sheet form. These sheets can have any desired “pre-laminated” length, such as slightly more than 8, 10, 12, 16, or 24 feet long, so that they can be trimmed to exact desired lengths after the lamination step has been completed. If the sheets of hardened composites are manufactured in a continuous press, rather than an enclosed mold, a “moving-belt” press is generally preferable, and it can use a releasing agent (such as a polyethylene film) to prevent the adhesive from sticking to the belts.

If desired, prior to lamination, the hardened sheets can be sawed into strips having any desired widths (such as 2, 4, 6, or 8 feet wide, as examples), to reduce the sizes and costs of the machines and the total force that will be required to carry out the laminating process.

Any cutting operation that is used to reduce an elongated sheet or board into narrower widths is usually referred to as “ripping” or “rip-cutting”, as distinct from “cross-cutting” (which is a cut that goes across the longest dimension of a sheet or board). If multiple strips are cut simultaneously (or nearly simultaneously) from a single large sheet in a manufacturing facility, the cutting process is usually referred to as “gang-ripping”. It can be carried out by various types of machines. In most manufacturing facilities, rather than mounting several saw blades on a single rotating axle, a preferable approach is to have each of several saw blades driven by its own rubberized belt, and several belts (and blades) can be driven by a single rotating axle (even more complicated equipment can be used, if desired). This use of belt drives can allow at least some of the blades to keep working and cutting, even if one or more blades become(s) jammed, broken, or otherwise unable to continue cutting, due to a knot or other obstacle in the wood. However, it should be recognized that the hardened sheets of materials disclosed herein are far more consistent and uniform than even plywood; these hardened sheets are comparable to fine-grained particle boards, of the types used in many bookshelves that are sold in easy-to-assemble kits.

Saw blades for use as described herein generally should have carbide tips, or other cutting tips made of exceptionally hard alloys. These cutting tips should be slightly wider than the thickness of the saw blades, to minimize friction, “grabbing”, and slowing of the saw blades by the adhesives in the materials being cut.

It should be kept in mind that any rip-cutting which may be done at this stage is only intended to reduce the sheet widths somewhat, generally into widths of at least about 2 feet or more. This will allow moderately wide sheets of material to be laminated together, to form full-thickness laminates that can then be rip-cut to their final widths. This sequence of steps will reduce or eliminate the need for edge-trimming operations to remove surplus adhesive that was squeezed out of the sides of strips as they were being laminated.

In general, the laminating step (i.e., the step in which two or more layers of hardened materials are glued together) preferably should be carried out before the final products are cut down to their final widths. This preferred sequence arises from the fact that in a laminating operation of this type, enough glue needs to be placed between the sheets or strips to ensure that the entire interface between two adjacent sheets or strips is reliably covered with adhesive, since even small gaps or voids in the adhesive coverage can lead to serious quality problems. However, when steps are taken to ensure that enough glue is emplaced in each adhesive layer to ensure very close to 100% coverage, the likelihood is very high that some quantity of the liquid glue, when subjected to pressure, will ooze out along the side edges of the sheets or strips that are being laminated. Therefore, the side edges likely will need to be trimmed, after the glue has hardened.

Accordingly, if a large strip or entire sheet is laminated first, and then sawed or otherwise cut into the widths that will provide the desired beams, boards, or planks, that sequence of steps will eliminate the need for an additional side-trimming step to remove excess and unwanted glue from the strips.

In the final rip-cutting operation that will be used to cut the laminates to their final widths, two or more rows of blades can be placed in first, second, and any successive cutting zones, to prevent the blades from crowding each other, and to ensure that the forces required to drive the freshly-laminated strips through the rip-cutting operations will not jeopardize the recently-hardened adhesive layers.

Regardless of which particular type of machine or method is used, methods and machines are known that can cut wide sheets of material into multiple strips having any desired widths, in mass-manufacturing processes that can achieve high levels of precision and consistency in the widths of the strips that are created.

Selection of Adhesives

The preferred choice of adhesives, for each of: (1) the layers of composite material, each layer containing a synthetic fiber matrix embedded with a hardened chemical adhesive, and, (2) the layers of adhesive that will be positioned between adjacent layers of fiber composite material in a complete laminated item, will depend on both technical and economic factors. These factors will vary, depending on the “grade” of a laminated material that is being made, and its size and intended use. In general, adhesives used for beams will in most cases need to be better and stronger than adhesives that may be acceptable for many types of boards or planks.

An adhesive combination that is believed to be well-suited for essentially any type of laminated beam, board, plank, or rail disclosed herein can be provided by using two different types of adhesives. To manufacture sheets, layers, or strips of a synthetic fiber composite that is hardened into a wood-like form, a combination of a poly-alcohol resin and a cyanate catalyst, selected to undergo a foaming reaction while forming a polyurethane adhesive, can be used. To subsequently manufacture laminated beams, boards, or rails from sheets or strips of those hardened fiber composite, a di-alcohol or poly-alcohol resin and a cyanate catalyst, which will form a polyurethane adhesive but which will not undergo a foaming reaction, can be used.

Both of these classes of adhesives are manufactured by companies such as BASF and Bayer, and they are sold by numerous distributors and retailers that can be identified quickly by an Internet search. Nearly all companies that sells such adhesives can provide sales consultants and technical specialists who can specify particular reagents that will provide the necessary and desired traits, for use on fibrous composites containing nylon or any other type of synthetic fiber.

Alternately, to reduce costs or for any other reason, any other type of adhesive that is known to bond to nylon or other synthetic fibers can be tested, to evaluate its potential for use in a particular type, size, or grade of beam or board as disclosed herein. As one example, various types of relatively inexpensive particulate adhesives that will melt and become extremely sticky, when heated to their melting temperature, can be distributed throughout and embedded into a needle-punched fiber mat, by means such as shaker trays positioned between the cross-lapper machines next to a conveyor system, as described above; these types of adhesives can and should be evaluated for use in creating the hardened wood-like layers that will be incorporated into a laminated beam or board. This type of approach is described in more detail in provisional patent application No. 60/404,465, filed on Aug. 14, 2002, the contents of which are incorporated herein by reference.

As another example, various types of relatively inexpensive single-component liquid adhesives can be spread between two sheets or strips of wood-like material, during a laminating operations; these can be tested to determine whether they can reduce the costs and mixing requirements that apply to resins and catalysts in polyurethane or other epoxy systems, without losing so much hardness that they render the resulting laminates effectively worthless even as boards or planks.

Alternately or additionally, it is feasible to use polypropylene or other “low melt” olefin materials as adhesives for nylon fibers, if the polypropylene or other olefin material is heated to a temperature that causes it to melt. This approach is described in more detail in PCT application WO 01/76869, cited above and incorporated herein by reference.

Accordingly, any candidate adhesive, in any of the low, medium, or high cost ranges, can be tested, using methods and machines known to those who work in this field, to evaluate the strength, durability, and other performance traits of that candidate adhesive, when used as a laminating adhesive with fiber composite layers that were made with any specific type of “internal” adhesive within the fiber matrix. Such tests can be used to determine whether any candidate adhesive is suitable for producing beams or boards of a certain size, that will qualify for a certain quality grade or rating, or that can meet any particular performance criteria that have been specified by a potential purchaser.

Government-Required Approvals; Material Safety Data Sheets

On the subject of laminated synthetic fiber composites “qualifying” as replacements for wooden studs and rafters, it must be recognized that both the ASTM (the American Society for Testing and Materials, www.astm.org) and the ANSI (the American National Standards Institute, www.ansi.org) are well-respected and well-run organizations that provide extremely useful and helpful published and open standards, for materials, and for methods of testing materials. These standards apply to any type of wood that is commonly used in construction of buildings that are “occupied” (for either residential or work purposes) by humans. Builders, mortgage companies, insurers, and local building inspectors all rely on these standards, and typically require any builder, and any building that is occupied by humans, to comply with these standards, in order to obtain permits, financing, insurance, and other required approvals.

Therefore, it will not be legally possible for any company to quietly “sneak in” a new type of unapproved, unqualified, or unsafe laminated beam made of synthetic fiber composites, in place of wooden materials that are recognized and approved for use in construction. Instead, any company that wishes to manufacture laminated beams made of synthetic fiber composites, for use as rafters, studs, or any other type of load-bearing beams in any building larger than a doghouse, will need to go through testing procedures that will satisfy ASTM and/or ANSI standards, and the results of those tests will need to be publicly disclosed.

These disclosures are published, by manufacturers, in the form of “Material Safety Data Sheets” (abbreviated as MSDS). Nearly any product that might jeopardize human safety or health, if it fails to perform safely, properly, and in the manner advertised, will usually be covered by some type of MSDS.

This is especially true in the case of chemical products, since all chemical companies realize that they can be highly vulnerable to product liability lawsuits, if one of their products causes adverse reactions in even a small fraction of the public that may suffer from allergies or other medical conditions that render some people hyper-sensitive to various chemicals. Clearly, the adhesives used in the laminates disclosed herein are chemicals. Accordingly, these laminates will need to undergo chemical testing, to ensure that (i) they do not cause or aggravate any unusual flammability conditions, and (ii) any solvents, vapors, or other trace gases they may emit will not cause medical problems.

For all of these reasons, the laminated beams that are covered by the claims herein will need to be covered by Material Safety Data Sheets, before they can reach or achieve any form of widespread commercial use. Accordingly, because these products cannot be used legally, in buildings occupied by humans, without being first tested by ASTM and/or ANSI approved procedures, and without being accompanied and supported by the information in Material Safety Data Sheets, those data sheets can and should be regarded as an important and even integral part of the products themselves.

Accordingly, certain claims contain the following language: “wherein the laminated article has dimensions, strength, and stiffness that render it useful and qualifiable as a substitute for pine studs and rafters used in wood-framed houses suited for human occupation . . . ” In this claim, the phrase “and qualifiable . . . for human occupation” is intended to reflect the commercial and regulatory constraints that will prevent the lawful use of these materials, in buildings intended for occupation by humans, until after the necessary ASTM and/or ANSI testing has been completed, and until Material Safety Data Sheets have been compiled and issued by a manufacturer.

In particular, these claim limitations can provide an objective and impartial way to distinguish the laminated beams disclosed herein, from various items of prior art that purport to offer or suggest various types of fiber-containing composite materials that, arguably or theoretically, might be useful for making rafters or studs for use in buildings that are occupied by humans. The relevant and useful question is not whether some type of fiber-containing composite might arguably or theoretically qualify for such use; instead, the question is whether any prior inventor or company has ever managed to actually create a laminated synthetic fiber composite that has been tested by objective and impartial standards, and that has been shown to be good enough, and strong enough, to qualify for lawful use as rafters or studs in buildings occupied by humans.

Improved Building Designs

Since the laminated synthetic building materials disclosed herein have strengths substantially higher than most forms of wood, they can enable improved building designs and constructions that use fewer materials. As just one example, these materials can make it possible to increasing the spacings between adjacent studs, joists, and rafters, without reducing safety. Accordingly, these buildings can be less expensive to build, and more energy efficient.

Thus, there has been shown and described a new and useful means for creating laminated beams and boards from synthetic fiber composites. Although this invention has been exemplified for purposes of illustration and description by reference to certain specific embodiments, it will be apparent to those skilled in the art that various modifications, alterations, and equivalents of the illustrated examples are possible. Any such changes which derive directly from the teachings herein, and which do not depart from the spirit and scope of the invention, are deemed to be covered by this invention.

1. A laminated synthetic article that can be used as a stud or rafter in building a framed house, comprising:
a. at least two layers of hardened wood-like material, each layer containing a composite material comprising a synthetic fiber matrix embedded with a hardened adhesive, and,
b. at least one hardened adhesive layer positioned between adjacent layers of hardened wood-like material,
wherein the laminated synthetic article has dimensions, strength, and stiffness that render it useful and qualifiable as a substitute for a pine stud or rafter used in a wood-framed house suited for human occupation.

2. The laminated synthetic article of claim 1, which has greater stiffness than a non-laminated composite material having an identical thickness and made of an identical synthetic fiber matrix embedded with the hardened adhesive.

3. The laminated synthetic article of claim 1, wherein at least one layer of hardened wood-like material contains nylon fibers.

4. The laminated synthetic article of claim 1, wherein at least one layer of hardened wood-like material contains a polyurethane adhesive.

5. The laminated synthetic article of claim 1, wherein at least one layer of hardened wood-like material contains an adhesive formed by heating polypropylene fibers to a melting temperature.

6. The laminated synthetic article of claim 1, wherein at least one layer of hardened wood-like material contains an adhesive formed by heating a particulate compound that was embedded in a fiber mat prior to said heating.

7. The laminated synthetic article of claim 1, wherein at least one hardened adhesive layer comprises a polyurethane adhesive made from non-foaming reagents.

8. A laminated synthetic building material, comprising:
a. at least two layers of hardened wood-like material, each layer comprising a chemical adhesive embedded within a matrix of synthetic fibers;
b. at least one adhesive layer positioned between two layers of hardened wood-like material,
wherein the laminated synthetic article has strength and stiffness that render it useful and qualifiable as a synthetic substitute for at least one type of wooden load-bearing structural beam in a conventional framed house suited for human occupation.

9. The laminated synthetic building material of claim 8, wherein the building material has a thickness, width, and length that render it useful as at least one type of load-bearing structural component selected from the group consisting of studs, joists, rafters, beams, posts, and truss members.

10. The laminated synthetic building material of claim 8, wherein the building material has a thickness, width, and length that render it useful as a flooring plank in an outdoor structure selected from the group consisting of decks, gazebos, docks, and piers.

11. The laminated synthetic building material of claim 8, which has greater stiffness than a non-laminated composite material having an identical thickness and made of an identical synthetic fiber matrix embedded with the hardened adhesive.

12. The laminated synthetic building material of claim 8, wherein at least one layer of hardened wood-like material contains nylon fibers.

12. The laminated synthetic building material of claim 8, wherein at least one layer of hardened wood-like material contains a polyurethane adhesive.

13. The laminated synthetic building material of claim 8, wherein at least one layer of hardened wood-like material contains an adhesive formed by heating polypropylene fibers to a melting temperature.

14. The laminated synthetic building material of claim 8, wherein at least one layer of hardened wood-like material contains an adhesive formed by heating a particulate compound that was embedded in a fiber mat prior to said heating.

15. The laminated synthetic building material of claim 8, wherein at least one hardened adhesive layer comprises a polyurethane adhesive made from non-foaming reagents.

16. A laminated synthetic building material, comprising:
a. at least two layers of hardened wood-like material, at least one of said layers containing a composite material made from a needle-punched nylon fiber mat embedded with a hardened adhesive, and,
b. at least one hardened adhesive layer positioned between adjacent layers of hardened wood-like material.

17. The laminated synthetic building material of claim 16, wherein the building material has a thickness, width, and length that render it useful as a flooring plank in an outdoor structure selected from the group consisting of decks, gazebos, docks, and piers.

18. The laminated synthetic building material of claim 16, which has greater stiffness than a non-laminated nylon fiber composite having an identical thickness and made of an identical needle-punched nylon fiber mat embedded with the hardened adhesive.

19. The laminated synthetic building material of claim 16, wherein at least one layer of hardened wood-like material contains an adhesive selected from the group consisting of polyurethane, polypropylene that was heated to a melting temperature, and a heat-activated particulate adhesive.

20. A building that contains multiple laminated synthetic articles of claim 16, wherein said multiple laminated synthetic articles are used as studs and rafters in said building, and wherein said multiple laminated synthetic articles are stronger and stiffer than pine studs and pine rafters, and wherein said building has increased spacing between adjacent studs, and increased spacing between adjacent rafters, when compared to standard spacing of pine studs and pine rafters.
